(19) United States
(12) Patent Application Publication
(10) Pub. No.: US 2007/0299709 A1
(43) Pub. Date: Dec. 27, 2007

(54) Automated performance quality tracking utility

(75) Inventors: Aaron D. Harrell, Charlotte, NC (US); Felix Ammay, Kings Mountain, NC (US); Jackie E. Walker, Charlotte, NC (US); Kathryn W. Childs, Concord, NC (US)

Correspondence Address: MERCHANT & GOULD BELLSOUTH CORPORATION, P.O. BOX 2903, MINNEAPOLIS, MN, 55402, US

(73) Assignee: BellSouth Intellectual Property Corporation

(21) Appl. No.: 11/474,621

(22) Filed: Jun. 26, 2006

(51) Int. Cl. G05B 19/418

(52) U.S. Cl. 705/8

(57) ABSTRACT

A performance quality tracking utility receives information associated with quality of work activity for organization members from managerial members and/or the members whose activity is being tracked. Evaluation of the quality by assigned percentages, ratings, and the like is used by the tracking utility to prepare reports in real time or accrued modes to managers of various levels. Administrative configuration of evaluation and report preparation parameters is accomplished using input from organization members with sufficient credentials. Output reports may also include raw or formatted data for other applications configured to consume the report data. Recipients of reports may define an extent (member or group levels), time, and other properties of the reports based on their credentials.

### TECHNICAL FIELD

Embodiments are related to tracking work performance quality. More particularly, the disclosed subject matter is related to computer-implemented methods, configurations, systems, and computer program products for facilitating tracking of quality of homogeneous and heterogeneous work activities in a hierarchically structured organization.

### BACKGROUND

For many organizations, the purpose of the job performance evaluation system is to promote employee development, to enhance employee productivity, to serve as a basis for sound personnel decisions, and to provide a permanent record of the performance of major job duties and responsibilities for employees within the organization.

Many aspects of work activities may be measured and evaluated in tracking organization wide performances. Some of those aspects are quantitative indicators such as attendance, output, and the like. Other aspects are qualitative such as customer satisfaction, quality of service, and the like. The task of job performance management may be further complicated by multiple layers of hierarchical structures of an organization with employees in various supervisory relationships. In some organizations, employees work in non-traditional hierarchy structures where non-supervising managers may be a better source of performance evaluation. The hierarchical complexity of organizational structures and subjectivity of activity evaluations may make it difficult to track and maintain performances of employees and consume valuable time of managers resulting in productivity loss.

### SUMMARY

Consistent with embodiments described herein, systems and methods are disclosed for tracking quality of work activities in an organization using computer systems. Key features or essential features of the claimed subject matter are not necessarily identified in this summary portion.

Embodiments are directed to tracking quality of work activities in an organization based on receiving activity information from reporting members and evaluations from managerial members within the organization. Evaluation of the quality by assigned percentages, ratings, and the like may be used by a tracking utility to prepare reports in real time or accrued modes to managers of various levels. Administrative configuration of evaluation and report preparation parameters may be assisted using input from organization members with sufficient credentials. Output reports at individual or group levels may also include raw or formatted data for other applications configured to consume the report data.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

FIG. 1 is a block diagram of an example computing operating environment;

FIG. 2 illustrates a system where example embodiments may be implemented;

FIG. 3 illustrates main components of quality tracking system for work activities in an organization;

FIG. 4 illustrates a conceptual diagram of interactions between components of a performance quality tracking system according to embodiments;

FIG. 5 illustrates a conceptual diagram of how a performance quality tracking system can be used according to an example scenario; and

FIG. 6 illustrates a logic flow diagram for a process of performance quality tracking according to one embodiment.

### DETAILED DESCRIPTION

As briefly described above, an automated performance quality tracking utility may be provided to track quality of work activities in an organization. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

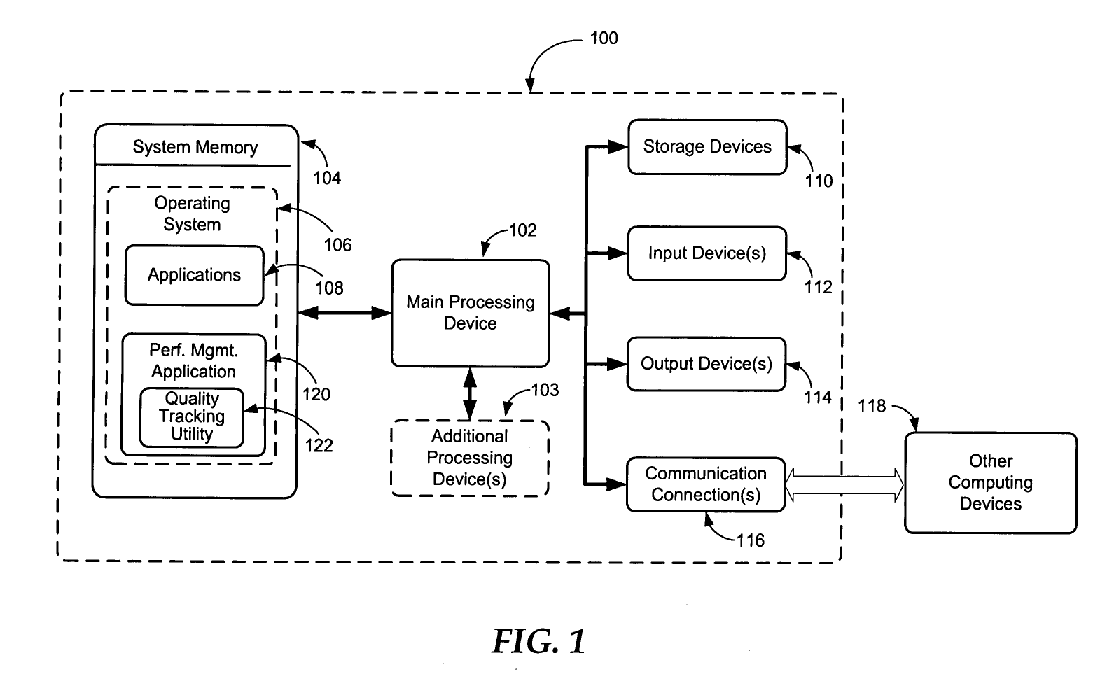

Referring now to the drawings, aspects and an exemplary operating environment will be described. FIG. 1 and the following discussion are intended to provide a brief, general description of a suitable computing environment in which the invention may be implemented. While the embodiments will be described in the general context of program modules that execute in conjunction with an application program that runs on an operating system on a personal computer, those skilled in the art will recognize that aspects may also be implemented in combination with other program modules.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

With reference to FIG. 1, one example system for implementing the embodiments includes a computing device, such as computing device 100. Computing device 100 typically includes a main processing device 102 and system memory 104. Computing device 100 may also include additional processing device(s) 103, which may be dedicated processors or enable distributed processing by coordinating with main processing device 102. The system memory 104 may be volatile (such as RAM), non-volatile (such as ROM, flash memory, etc.) or some combination of the two. System memory 104 typically provides an environment for an operating system 106 to be executed for controlling the operation of computing device 100 and execution of other programs (applications). Software applications 108 and performance management application 120 are examples of programs or program modules that may be executed under the control of operating system 106 in system memory 104. Additional operating systems or programs may also be executed within system memory 104 outside the control of operating system 106. Performance management application 120 may coordinate tracking of quantitative and/or qualitative aspects of work activities, maintain reports, schedule future activities, and the like.

According to some embodiments, performance management application 120 may include one or more modules responsible to individual tasks in managing performance related activities. One such module may be quality tracking utility 122. Quality tracking utility 122 may perform tasks such as monitoring quality of work activities based on inputs from employees and/or managers, preparing and providing reports to higher level managers, other applications, and the like. Quality tracking utility 122 may be an integrated part of a performance management application 120 or a separate application. Quality tracking utility 122 and performance management application 120 may communicate with other applications running on computing device 100 or on other devices. Furthermore, performance management application 120 may be executed in an operating system other than operating system 106.

The computing device 100 may have additional features or functionality. For example, the computing device 100 may also include data storage devices 110 (removable and/or non-removable) such as, for example, magnetic disks, optical disks, or tape. Computer storage media may include volatile and nonvolatile, removable and non-removable media implemented in any method or technology for storage of information, such as computer readable instructions, data structures, program modules, or other data. System memory 104 and storage devices 110 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100.

Computing device 100 may also include input device(s) 112 such as a keyboard, a mouse, a pen, a voice input device, a touch input device, etc. Furthermore, output device(s) 114 such as a display, a speaker, a printer, etc. may also be included. These devices are well known in the art.

Communication connections 116 may be included in computing device 100 to allow the device to communicate with other computing devices 118, such as over a network in a distributed computing environment, for example, an intranet or the Internet. Communication connections 116 exemplify various communication media. Communication media may be embodied by computer readable instructions, data structures, program modules, or other data in a modulated data signal, such as a carrier wave or other transport mechanism, and include any information delivery media.

By way of example, and not limitation, communication media may include wired media such as a wired network or direct-wired connection, and wireless media such as acoustic, RF, infrared and other wireless media. The term computer readable media as used herein refers to both storage media and communication media.

Typical components of a computing device where embodiments may be implemented are shown in FIG. 1. The implementation of embodiments is, however, not limited to computing device 100. Other computing devices with different components, configurations, and the like, may be used to execute computer readable instructions implementing embodiments described herein without departing from a scope and spirit of the claimed subject matter.

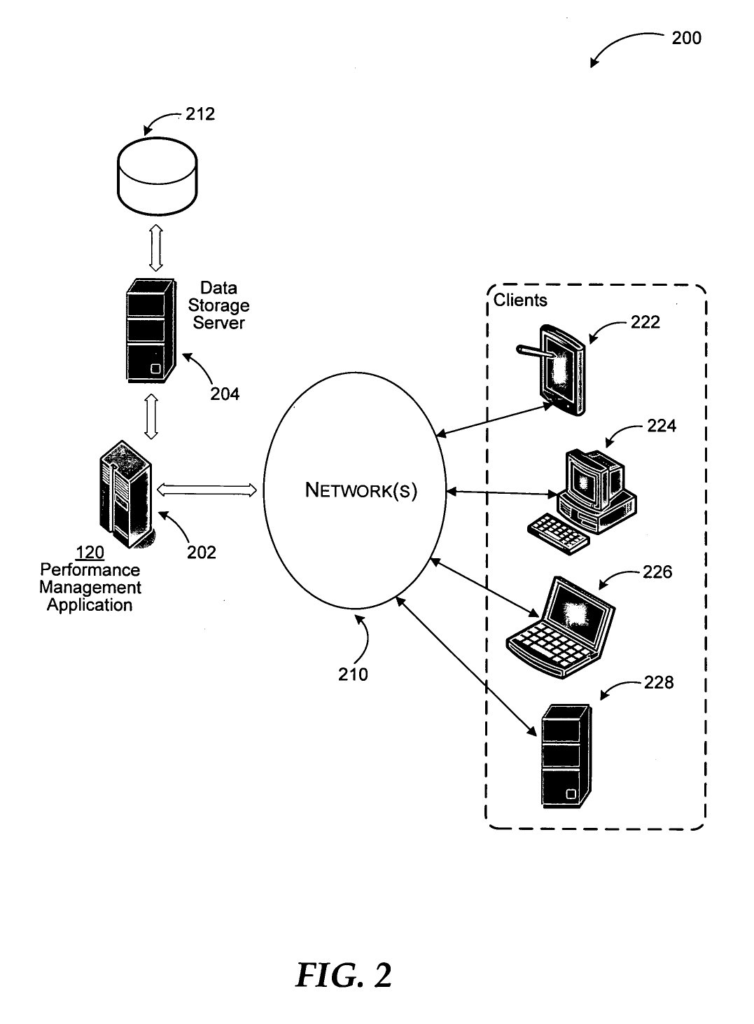

Referring to FIG. 2, a system 200 where example embodiments may be implemented, is illustrated. System 200 may comprise any topology of servers, clients, Internet service providers, and communication media. Also, system 200 may have a static or dynamic topology. The term “client” may refer to a client application or a client device employed by a user to perform business logic operations. Performance management application 120 may be one or more programs or a server machine executing programs associated with the server tasks. Both clients and application servers may be embodied as single device (or program) or a number of devices (programs). Similarly, data sources may include one or more data stores, input devices, and the like.

A performance management application 120 may be run centrally on server 202 or in a distributed manner over several servers and/or client devices. Performance management application 120 may include implementation of a number of organizational management systems such as time tracking, performance evaluation, activity scheduling, and the like. A number of other applications may also be configured, deployed, and shared in system 200. In addition, the performance management application 120 may also be run in one or more client devices and information exchanged over network(s) 210.

Data store 212 is an example of a number of data stores that may be utilized to store data associated with activity tracking. Data store 212 may be managed by data storage server 204 or directly accessed by performance management service 202 or any one of the clients.

Users such as employees, managers of various levels, and administrators may interact with server 202 running performance management application 120 with the quality tracking utility 122 from client devices 222, 224, 226, and 228 over network(s) 210. In one embodiment, portions or all of the performance management application 120 may reside on any one of the client devices 222, 224, 226, and 228. In such an embodiment, data may be stored in data store 212 without an involvement of server 202.

According to some embodiments, users may be provided one or more user interfaces (‘“UIs”) to enter data associated with tracking activities such as inspections, entries, administrative inputs, and the like. Other users, such as supervising managers, may receive reports prepared by the performance tracking application 120.

Network(s) 210 may include a secure network such as an enterprise network, or an unsecure network such as a wireless open network. Network(s) 210 provide communication between the nodes described above. By way of example, and not limitation, network(s) 210 may include wired media such as a wired network or direct-wired connection, and wireless media such as acoustic, RF, infrared and other wireless media. Many other configurations of computing devices, applications, and data storage may be employed to implement a performance management system with activity tracking.

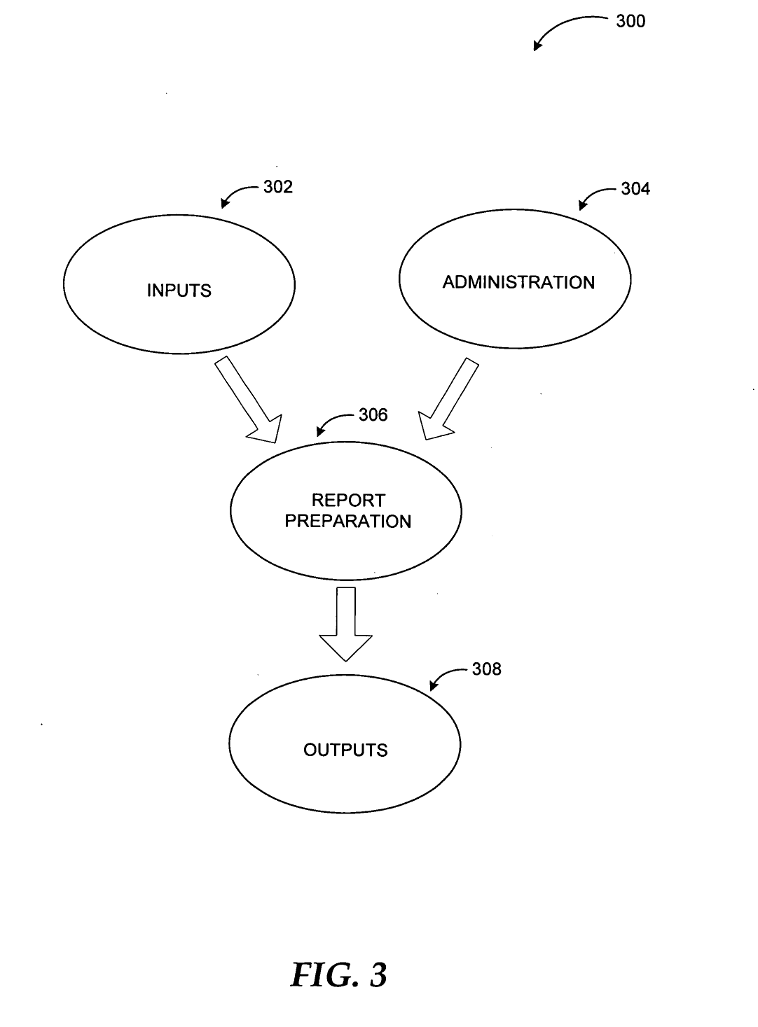

Now referring to FIG. 3, conceptual diagram 300 illustrates main components of the system 200 for tracking work activities in an organization. The system 200 according to embodiments may be implemented in any topology of processing systems, storage systems, source systems, and configuration systems.

At the core of the system 200 is report preparation component 306, which may be part of the quality tracking utility 122 and receive inputs associated with activities, receive administrative configuration information, and prepare reports based on the received information.

Inputs 302 include any information provided to the system 200 by the organization members whose activities are being tracked or by other members related to the tracked activities such as manager reviews. Inputs 302 may be received through a user interface that prompts users to enter information by selections or textual entries. Inputs 302 may also include information received from other sources such as quantitative work activity data imported from a database.

Administration 304 represents a component of the system 200 that is tasked with managing configuration parameters. Administrative input may be provided by dedicated administrative personnel, by the members whose activities are being tracked, or by managerial members. Administrative input may be used to set up report preparation parameters such as defining groups, report types, reporting periods, and the like. Administrative input may also be used to define activity or member specific properties, such as quality indicator limits, performance ratings, organization member history e.g. years at the organization, job difficulty level, etc., some of which may be utilized in evaluating work activity quality and preparing reports.

Outputs 308 may include results of work activity quality tracking. Outputs 308 may be in the form of reports based on the activity input and the administrative information. The reports may include any form of presentation such as charts, histograms, diagrams, and the like. The reports may be at organization member level, at a group level, or at organizational level. Moreover, the reports may be prepared based on requested time periods, pre-defined time periods, and the like. According to other embodiments, the reports may also include raw or formatted data that can be consumed by other applications such as statistical analysis applications, scheduling applications, and the like. According to further embodiments, outputs 308 may also include alerts that are issued to managerial members based on predetermined thresholds when a tracked member's performance falls below or exceeds the threshold.

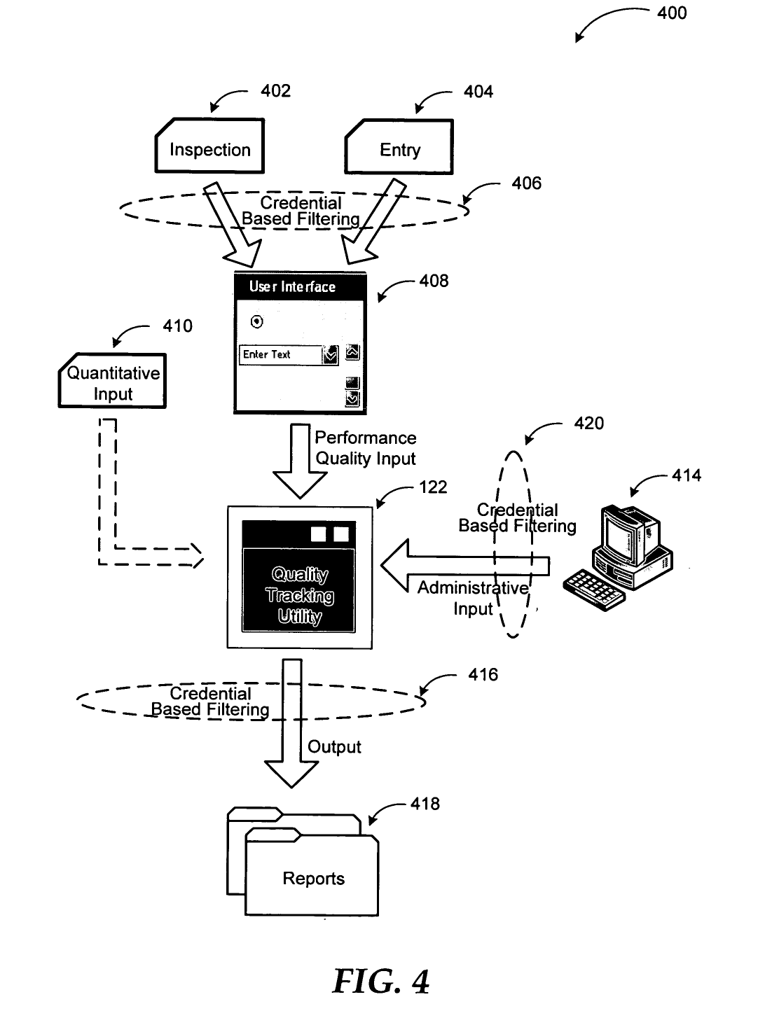

FIG. 4 illustrates conceptual diagram 400 of interactions between components of performance management application 120 according to embodiments. Quality tracking utility 122 is at the core of the system 200 receiving information as inspections, entries, quantitative input, and administrative input.

Inspection 402 is one type of input that may be provided by managerial organization members using user interface 408. Inspection 402 may enable the manager to enter information associated with the tracked activity such as type, inspection period, inspection criteria, and the like.

Entry 404 is another type of input that may be provided by the employees or organization members whose performance is being tracked. Examples of entries may include type of activity such as training, coverage, disciplinary action, and the like.

According to some embodiments, providing input (inspections or entries) to quality tracking utility 122 may be subject to user credential based filtering 406. For example, providing input may be based on a permission level of an employee (or manager). Permission levels may determine whether a user can provide any input at all or whether the user can provide certain portions of activity input. According to another example, a permission level may authorize an employee or manager to select from predefined ratings or percentages for inspections only, while another permission level may authorize the manager to define new ratings or modify percentages assigned to ratings.

Inspections and Entries include work activity information and feedback associated with the quality of work activity, which is typically qualitative. According to other embodiments, quantitative information, such as attendance records, work output, provided services, and the like, may also be used by quality tracking utility 122. For example, inspection forms from a manager may include rating of a particular work activity for an employee. The rating may then be weighted based on the experience of the employee e.g. years on the job. Quantitative information may be provided by other members of the organization through another user interface or imported from another data store.

Administrative input includes any information provided by an administrator 414 associated with the configuration of quality tracking utility 122. Such information may include adding or removing employees from the report preparation database, defining predetermined evaluation periods, defining ratings, defining report types and parameters, and the like. Administrator 414 may include an application or a program module associated with quality tracking utility 122 that enables any organization member with sufficient permission level to enter administrative input. As mentioned previously, such members may include employees themselves, managers, and dedicated administrative personnel. Providing administrative input may also be subject to credential based filtering 420. A filtering module may determine the credentials of a user before allowing them to enter or modify configuration(s) of the quality tracking utility 122.

Quality tracking utility 122 may provide outputs in the form of reports 418. Reports 418 may include any type of charts, histograms, diagrams, and the like, that are prepared based on the collected inspection and entry information. Report parameters such as time period, individual or group level, and the like, may be predefined or determined by the requesting organization member. For example, quality tracking utility 122 may provide a number of “canned” reports that include performance quality information for each individual and certain predefined groups within the organization at biweekly periods. In addition, report requesters may be enabled to define their own groups for the report and their own time periods.

In addition to charts, histograms, diagrams, and the like, quality tracking utility 122 may also provide raw or formatted data to other applications for report generation, analysis, scheduling, and similar purposes. Furthermore, providing reports 418 may also be subject to credential based filtering 416. Similar to input or administrative information filtering, a report requestor's permission level may be checked before providing the report 418. Part or all of the report 418 may be withheld, if the requestor does not have sufficient permission level. The credential based filtering for all three components may be performed by a single module (or application) or separately as part of each task.

Quality tracking utility 122 may be any application such as an executable computer program, a web application, and the like. The examples provided above are for illustration purposes only. Individual components of a performance quality tracking system 200 may be implemented in any way using the principles described herein including additional forms of input or output. Furthermore, inputs are not limited to the example inspection and entry forms described herein. Other types of input forms known in the art may be used to provide activity related information to the quality tracking system 200. Similarly, different forms of output in addition to reports and report data may be implemented using the principles described herein.

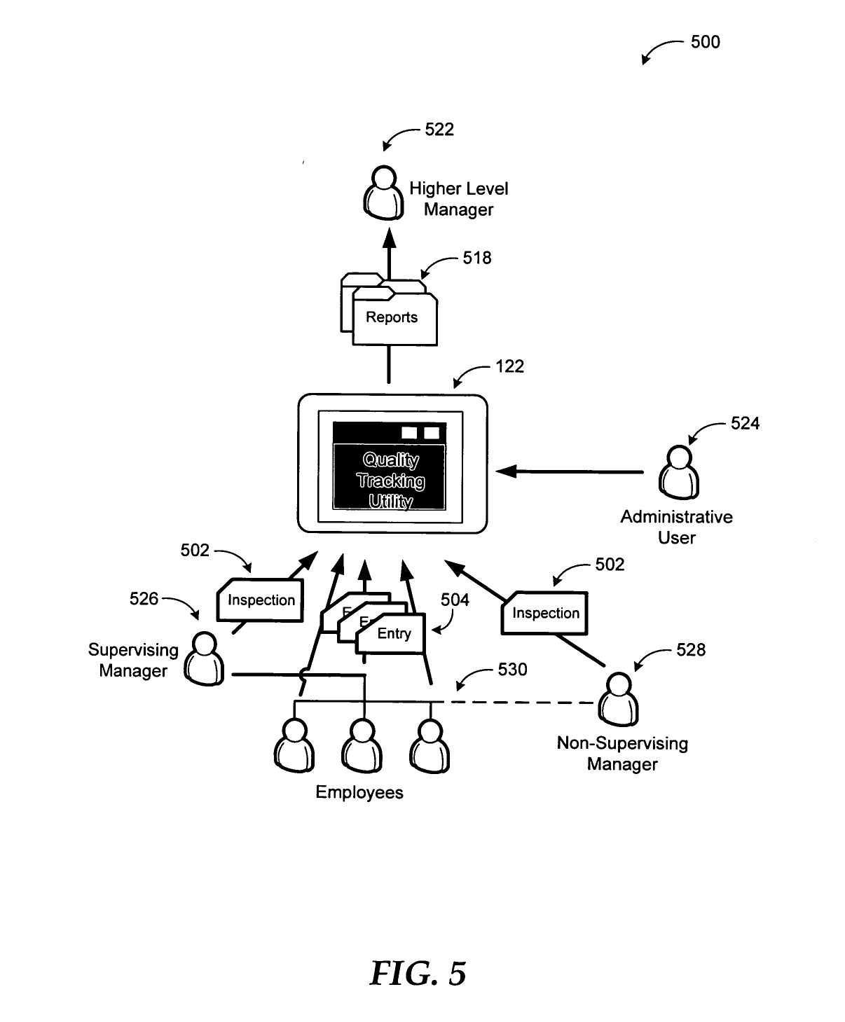

FIG. 5 illustrates conceptual diagram 500 of how performance management application 120 can be used according to an example scenario. The example scenario includes employees of an organization performing work activities for a supervising manager and a non-supervising manager who evaluate the employees' performance. Reports are then provided to a higher level manager.

According to the example scenario, employees 530 provide information about their activities, such as type of activity, duration, and the like, using entry forms 504. Part of their work (e.g. training) may be performed for a supervising manager 526. Another part e.g. service may be performed for non-supervising manager 528. Each manager provides their evaluation of the employees' performance using inspection forms 502. The forms may be provided to the managers through a user interface managed by quality tracking utility 122. The user interface may provide activity and employee related information and prompt the manager to enter their evaluation by selecting a value on a percentage scale for the quality of the performance, a rating value, and the like. Ratings may include a predefined number of levels such as excellent, satisfactory, and non-satisfactory. Ratings may also be based on predefined ranges on the percentage scale.

Once the managers provide their input, quality tracking utility 122 can prepare reports for individual employees or for selected groups among them e.g. for each department, unit, workgroup, etc. In preparing the reports, administrative information provided by administrative user 524 is used as well. For example, administrative user 524 may provide predefined ranges for the ratings, time periods, employee specific information, and the like. The reports 418 may be prepared based on predefined formats e.g. charts, tables, combinations or based on parameters provided by the requesting higher level manager 522. Higher level manager 522 represents any user that is authorized to receive reports prepared by quality tracking utility 122 based on the received information. As suggested by the name, higher level manager 522 may be an organization member at a higher hierarchy level or one of the managers providing activity input.

The architecture and scenarios described in FIGS. 3 through 5 are for illustration purposes only and do not constitute a limitation on embodiments. Other configurations of a performance quality tracking utility system may be implemented without departing from a scope and spirit of the present invention.

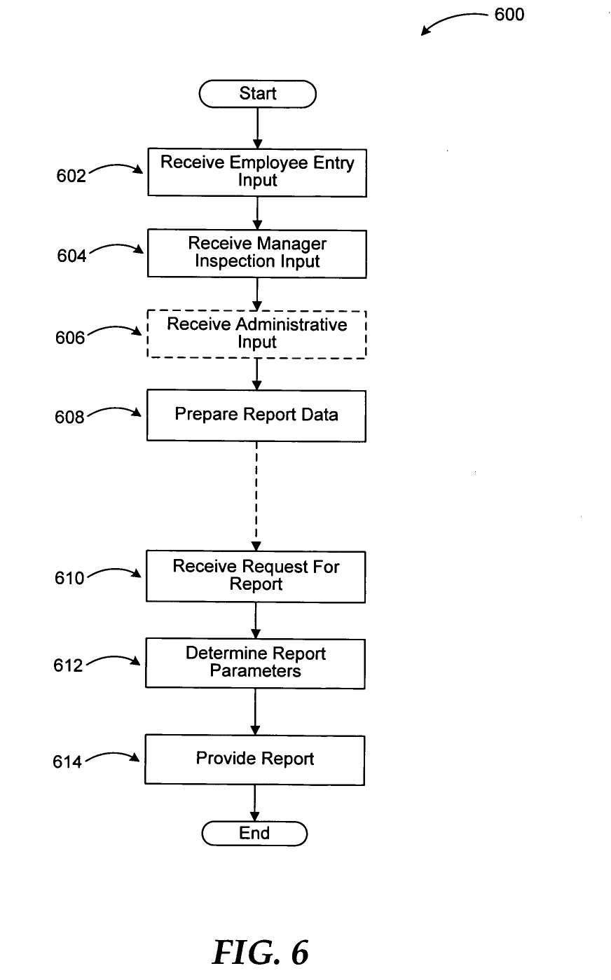

FIG. 6 illustrates a logic flow diagram for a process 600 of performance quality tracking according to one embodiment. Process 600 may be implemented in performance management application 120.

Process 600 begins with operation 602, where the quality tracking utility 122 receives an entry input from an employee. The entry may include activity type, description, time and/or duration of the activity, and any other information associated with the activity such as exceptions. Processing moves from operation 602 to operation 604.

At operation 604, the quality tracking utility 122 receives an inspection input from a manager. The inspection input may include inspection criteria, evaluation, comments, and any other information associated with evaluating quality of the activity. Processing moves from operation 604 to optional operation 606.

At optional operation 606, the quality tracking utility 122 receives administrative input. Administrative input may include any information associated with configuring the quality tracking utility, such as employee personal information, available activity types, report preparation schedule, group structures for group reports, and the like. Processing advances from optional operation 606 to operation 608.

At operation 608, the quality tracking utility 122 prepares one or more reports 418 based on the received information. According to some embodiments, reports 418 may be prepared in real time mode and made available to recipients. According to other embodiments, reports 418 may be prepared on demand at the time of request. Report data may also be used to issue alerts to requesting managers when the evaluation of an employees' (or group's) performance drops below or exceeds a preset threshold. In such cases, the alerts may be provided by electronic mail, instant messaging, facsimile, voicemail, and the like.

As illustrated by the dashed progress line, processing within the performance management application 120 may proceed from operation 608 to operation 610, where the quality tracking utility 122 receives a request for a report. A report request may include custom parameters for a report, upon which a custom report may be prepared by the quality tracking utility. Credentials of a report requestor may be used to determine permission levels for that organization member in order to restrict who can request a report from the system or what type of report(s) may be requested. The credentials may also be used to store personal preferences for each report requestor associated with report type, report schedule, and the like. Processing moves from operation 610 to operation 612.

At operation 612, the quality tracking utility 122 determines the requested report type. Report types may include reports for individual activity reporters, reports for groups of employees, and the like. Report types may also include presentation types such as charts, diagrams, histograms, raw data, formatted data, and the like. As mentioned above, the report request may include customization of readily available reports, which may be accommodated by the quality tracking utility. Processing advances from operation 612 to operation 614.

At operation 614, the quality tracking utility 122 provides the requested report(s) 418 to the requesting user or application. Reports 418 may be provide by electronic mail, as output to a selected printer, as a downloadable file, and the like. After operation 614, processing moves to a calling process for further actions.

The operations included in process 600 are for illustration purposes. Tracking work activities, qualitatively and quantitatively may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for tracking performance quality, comprising:
receiving a first information associated with a work activity from a reporting member of an organization;
receiving a second information associated with a quality of the work activity from a managing member of the organization;
preparing a report based on the received first and second information;
receiving a request for the report; and
providing the report in response to the request.

2. The method of claim 1, further comprising:
receiving configuration information associated with tracking the quality of the work activity.

3. The method of claim 1, further comprising:
preparing a plurality of reports based on the received first and second information; and
providing one of the plurality of the reports in response to the request.

4. The method of claim 1, wherein the first information includes at least one from a set of: a description of the work activity, a duration of the work activity, and an exception associated with the work activity.

5. The method of claim 1, wherein the second information includes at least one from a set of: an inspection criterion, an evaluation of the quality of the work activity, and a comment.

6. The method of claim 2, wherein the configuration information includes at least one from a set of: an activity type, personal information associated with the organization member, available report types, a report preparation schedule, and a permission level associated with a report recipient.

7. The method of claim 2, wherein the configuration information is received from one of: an administrative member, the reporting member, the managing member, and a report receiving member of the organization.

8. The method of claim 1, wherein the report includes at least one from a set of: a chart, a diagram, a histogram, raw data, and formatted data; and wherein the report is provided to one of: a report receiving organization member and an application.

9. The method of claim 8, wherein the report is provided by one of an electronic mail, an instant message, a facsimile, downloadable data, and a voicemail.

10. The method of claim 1, further comprising:
issuing an alert, if an evaluation value associated with the report drops below a predefined threshold value.

11. The method of claim 1, further comprising:
issuing an alert, if an evaluation value associated with the report exceeds a predefined threshold value.

12. The method of claim 1, further comprising:
restricting access for at least one of: providing the first information, providing the second information, providing configuration information, and receiving the report based on a credential of an organization member.

13. The method of claim 1, further comprising:
receiving quantitative data from a data source associated with the work activity; and
using the quantitative data in preparing the report.

14. The method of claim 13, wherein the quantitative data includes at least one of:
attendance and work throughput.

15. A computer-readable medium having computer executable instructions for tracking a quality of a work activity, the instructions comprising:
receiving an entry associated with a work activity from an employee;
receiving an inspection associated with the work activity from a first manager;
receiving an administrative input from an administrator;
preparing a report based on the received entry, inspection, and administrative input;
receiving a request for the report from a second manager;
customizing the report, if the received request includes customization information; and
providing the report to one of the second manager and an application designated by the second manager, wherein the application includes at least one from a set of: an analysis application, a scheduling application, a presentation application, and a performance evaluation application.

16. The computer-readable medium of claim 15, wherein the instructions further comprise:
preparing the report using evaluation information included in the inspection, wherein the evaluation information includes at least one of: a percentage scale based assessment and a rating of the quality of the work activity.

17. The computer-readable medium of claim 16, wherein the rating is determined based on a set of predefined ranges along the percentage scale.

18. A system for tracking a quality of employee activities, comprising:
a first user interface (UI) module configured to:
a first information associated with a work activity from an employee;
a second user interface (UI) module configured to:
a second information associated with the work activity from a manager;
a tracking application arranged to:
prepare a plurality of reports based on the received first and second information;
receive configuration information from an administrative user;
receive a request for a report; and
customize one of the plurality of reports based on the configuration information and the request; and
an output user interface (UI) module arranged to:
provide the customized report.

19. The system of claim 18, wherein the output UI module is further arranged to provide an alert based on one of the second information and the report using at least one from a set of: an electronic mail, an instant message, a print-out, a voicemail, and a log-in message.

20. The system of claim 18, wherein the tracking utility is further configured to receive at least one of: attendance data and work throughput data to use in preparing the plurality of reports.
